(19) United States
(12) Patent Application Publication
(10) Pub. No.: US 2011/0040798 A1
(43) Pub. Date: Feb. 17, 2011

(54) Personal health record accessible by cell phone

(76) Inventors: Benjamin David Tobacman, Burr Ridge, IL (US); Joanne Kramer Tobacman, Burr Ridge, IL (US)

Correspondence Address: Benjamin Tobacman, 161 Ashton Drive, Burr Ridge, IL, 60527, US

(21) Appl. No.: 12/541,953

(22) Filed: Aug. 16, 2009

(51) Int. Cl. G06F 17/30

(52) U.S. Cl. 707/802; 707/E17.044

(57) ABSTRACT

The invention permits the documentation of medical information on a cell phone, enabling improved communication between health care provider and patient. Electronic medical records will be transferable to the cell phone and be stored. The owner of the cell phone will be able to maintain a longitudinal record of health information and be able to share this information with different health care providers. The portability of medical information by the patient will enable continuity, accuracy, and accessibility

The invention consists of a Personal Health Record (PHR) intended for display and use on a cell phone. Twenty screens are included as the basic series of displays and are presented as the series of drawings (see II). Cell phone users would complete information appropriate for each screen by using the cell phone keyboard and the cell phone function keys. This would lead to an individualized, private PHR, stored on the cell phone, accessible for updating and for sharing with health care providers. Electronic medical records of the health care provider, including laboratory and imaging data and notes, could also be directly downloaded on to the patient's cell phone.

The invention consists in the provision of PHR on the cell phone, rather than another medium of communication. The uniqueness of the invention is in the utilization of the hand-held cell phone for display of personal medical records. The screens are derived from previously copyrighted material used in a PHR in a paper, hard-copy format by Dr. J. K. Tobacman.

It is anticipated that one of the commercial cell phone producers will be interested in further development of this invention, so that existing technology pertaining to cell phone function and software could be applied to the PHR. Additional screens to the basic twenty screens that are displayed in the following description could be included as “Additional Notes” pages.

### DESCRIPTION OF THE PREFERRED EMBODIMENT

The invention consists of the basic screens that are included as “Drawings” that constitute the original personal health record that was developed in a print format. In this invention, these screens are formatted to be on a cell phone, which becomes a source for personal medical information to be maintained by a patient. In addition, information in electronic medical records of the health care providers will be transferred to the cell phones, enabling patients to have a portable, longitudinal record of their health care information.

The drawings of the basic set of screens (pages 1-20) which are designated as the “Personal Health Record” follow. The images are presented in only one comprehensive view, but may be seen line by line on the cell phone screen. Data will be entered by the cell phone owner (“patient”), who will advance the screen from line to line and page to page.

### CROSS-REFERENCE TO RELATED APPLICATIONS

NA

### STATEMENT REGARDING FEDERALLY SPONSORED RESEARCH OR DEVELOPMENT

NA

### REFERENCE TO SEQUENCE LISTING, A TABLE, OR A COMPUTER PROGRAM LISTING COMPACT DISC APPENDIX

NA

### BACKGROUND OF THE INVENTION

The invention is applicable to the field of medical and health administration and to patient records. It is intended to provide a longitudinal, portable, accurate medical record for patients that they can take with them to their health care providers.

### BRIEF SUMMARY OF THE INVENTION

The claimed invention provides a novel means of access to medical information and a tool for patient participation and education about their health and medical care. It provides an opportunity for the patient to participate in the communication of health information and circumvents issues with regard to privacy, since the patient will possess the health information and can share it with health care providers in different locations.

### BRIEF DESCRIPTION OF THE VIEW OF THE DRAWINGS

### Pages 11-32 of Application

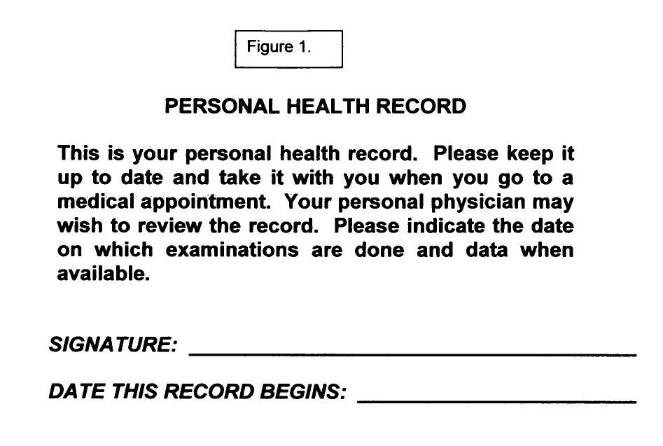

FIG. 1. title page

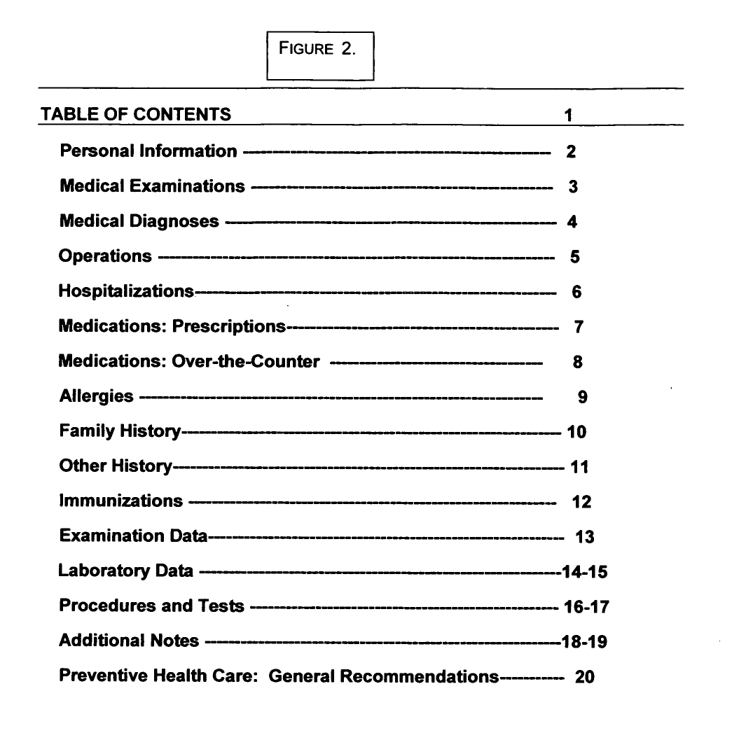

FIG. 2. Page 1 of personal health record.

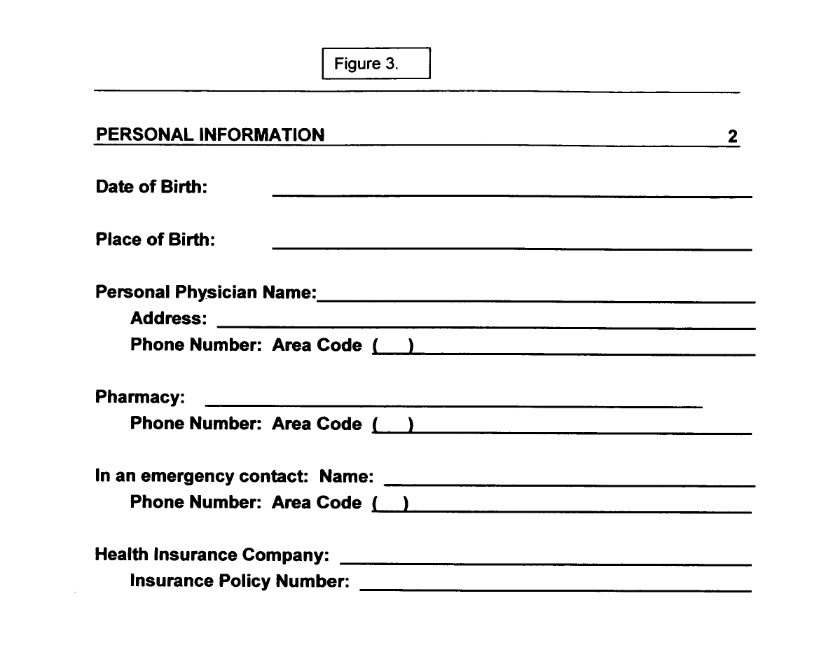

FIG. 3. Page 2 of personal health record.

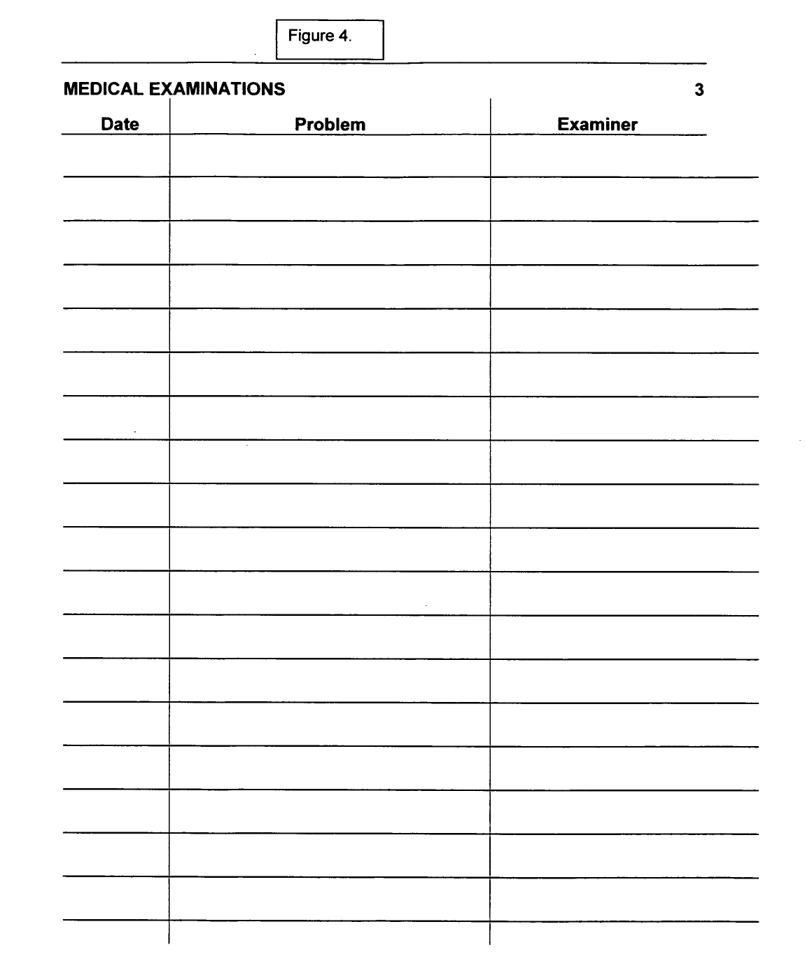

FIG. 4. Page 3 of personal health record.

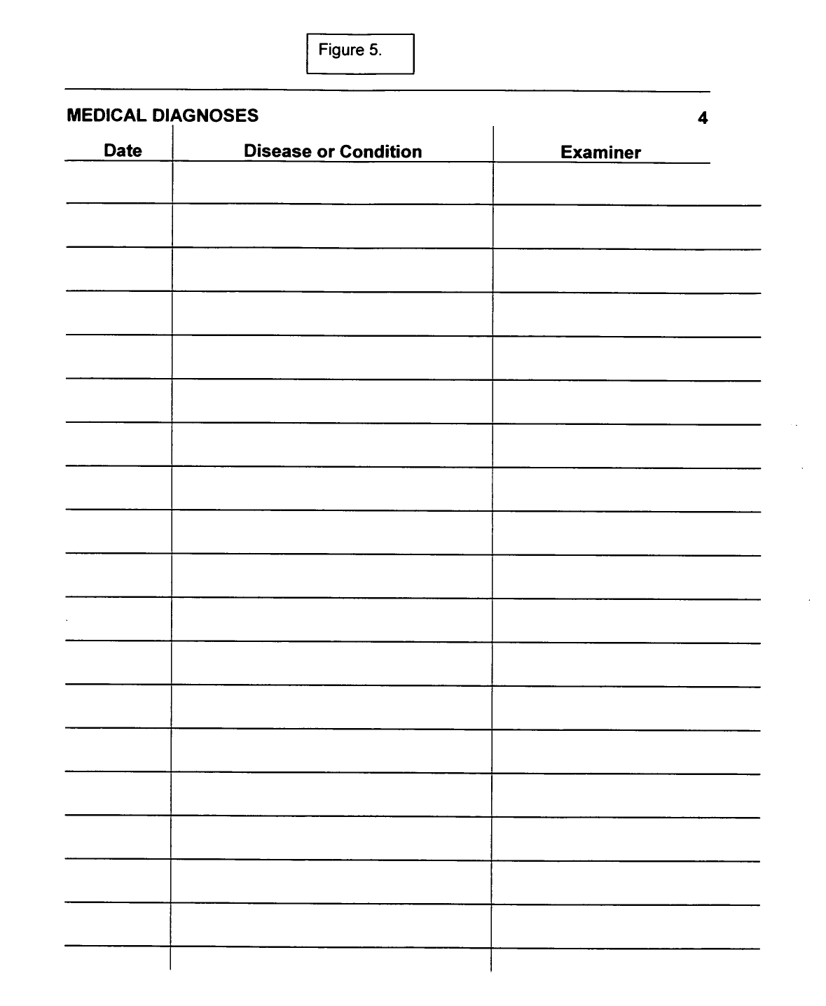

FIG. 5. Page 4 of personal health record.

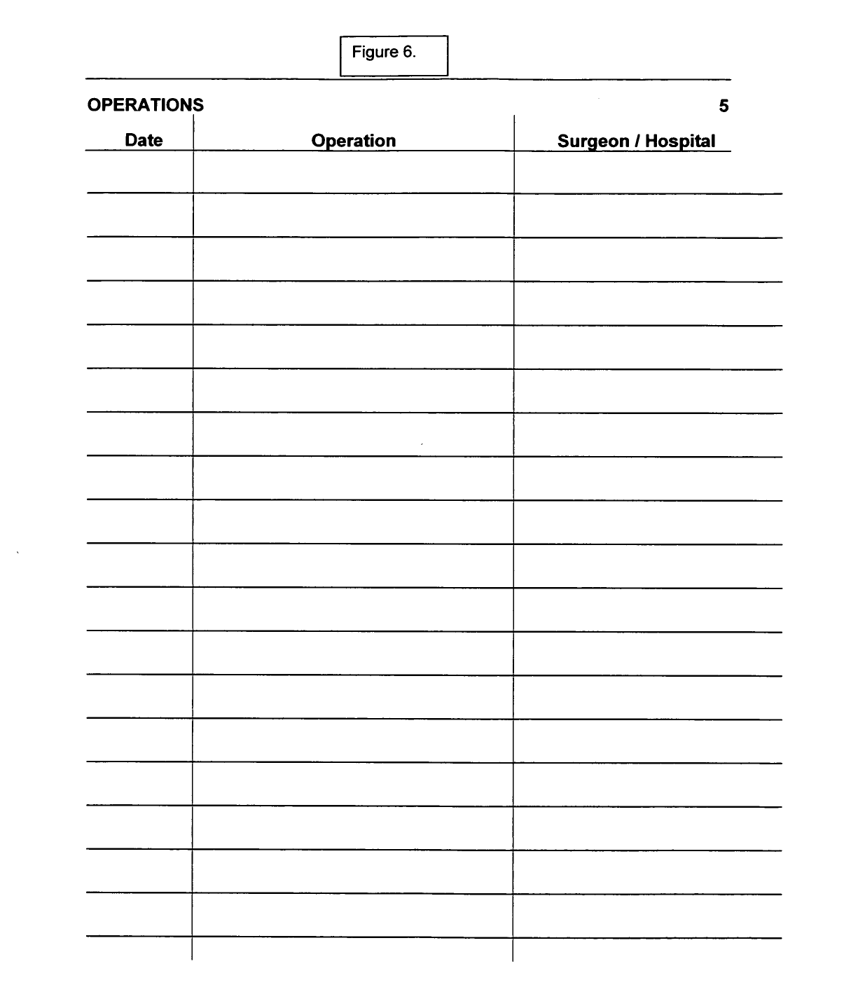

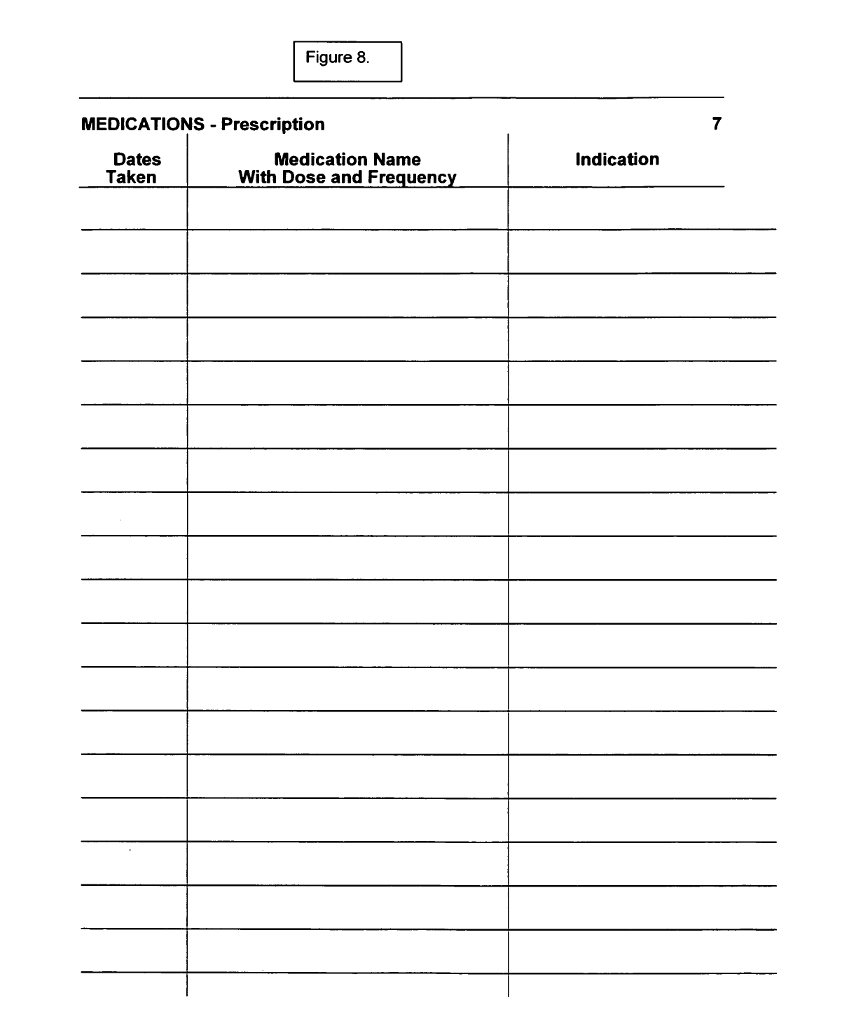

FIG. 6. Page 5 of personal health record.

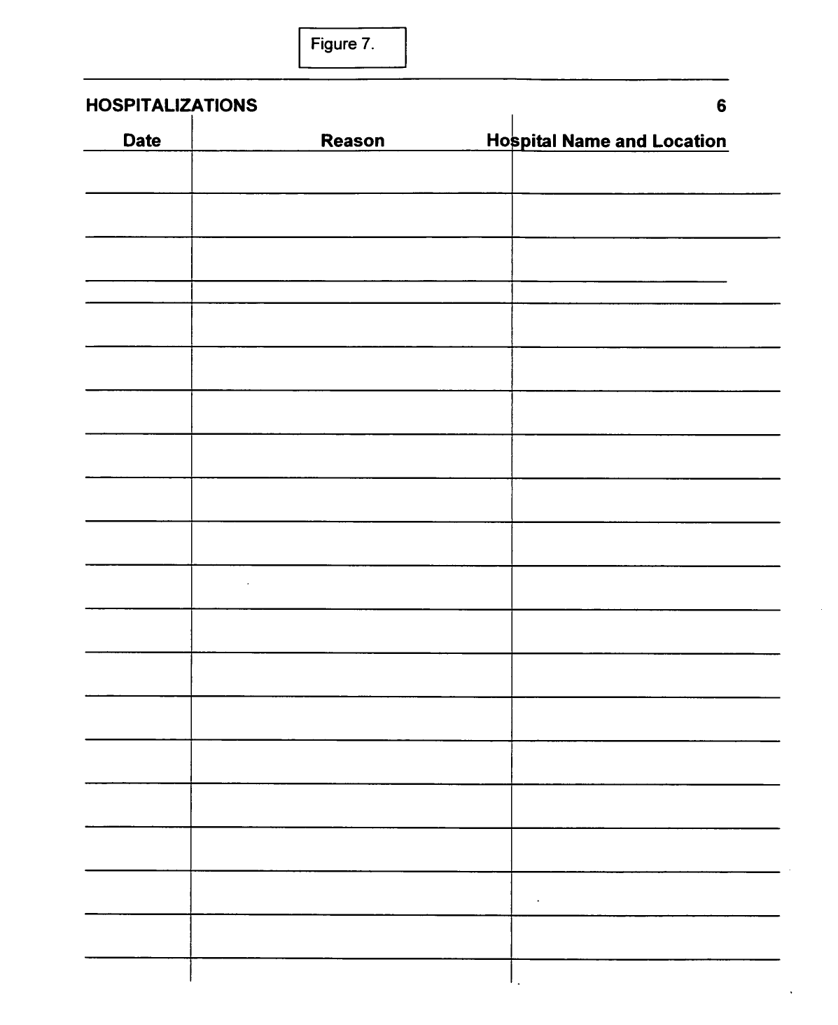

FIG. 7. Page 6 of personal health record.

FIG. 8. Page 7 of personal health record.

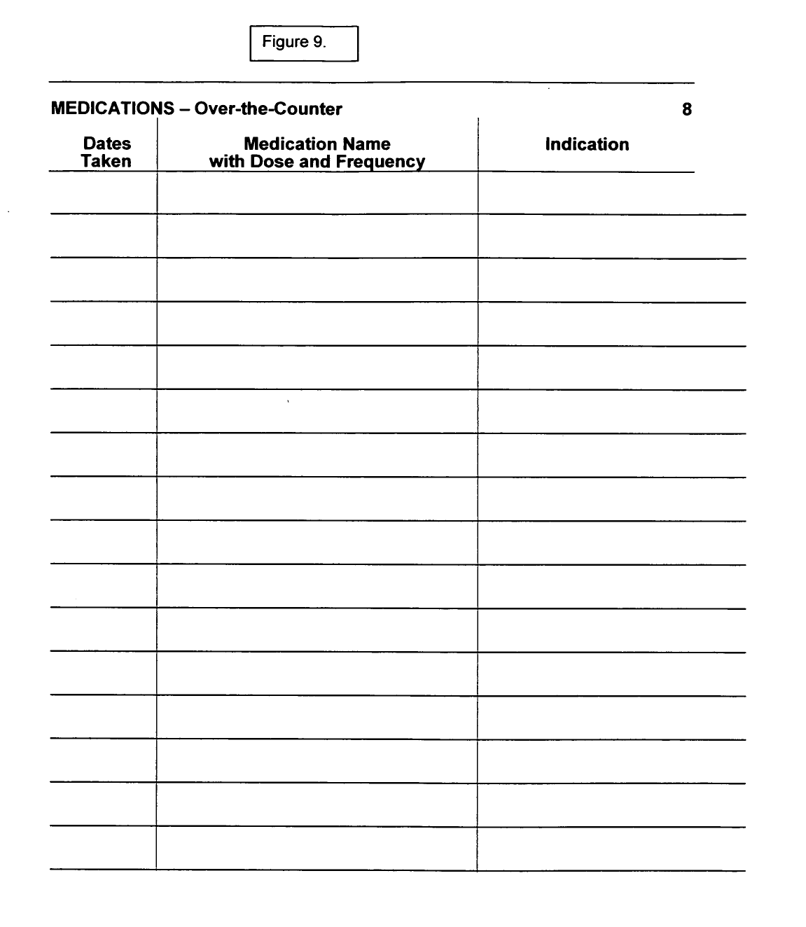

FIG. 9. Page 8 of personal health record.

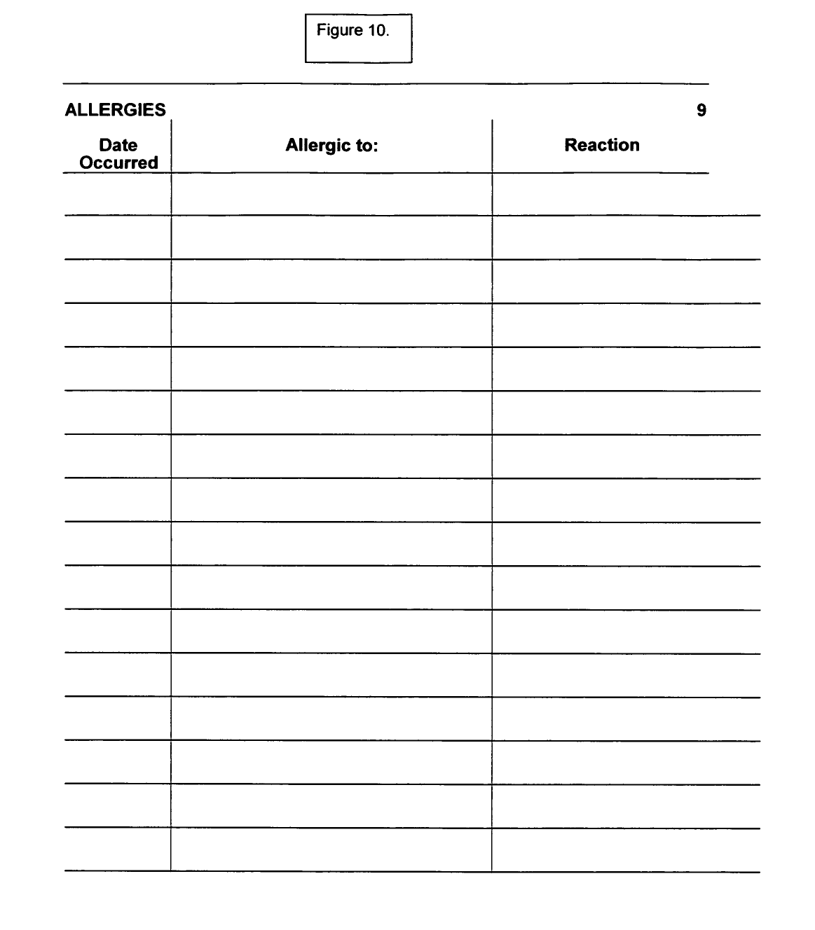

FIG. 10. Page 9 of personal health record.

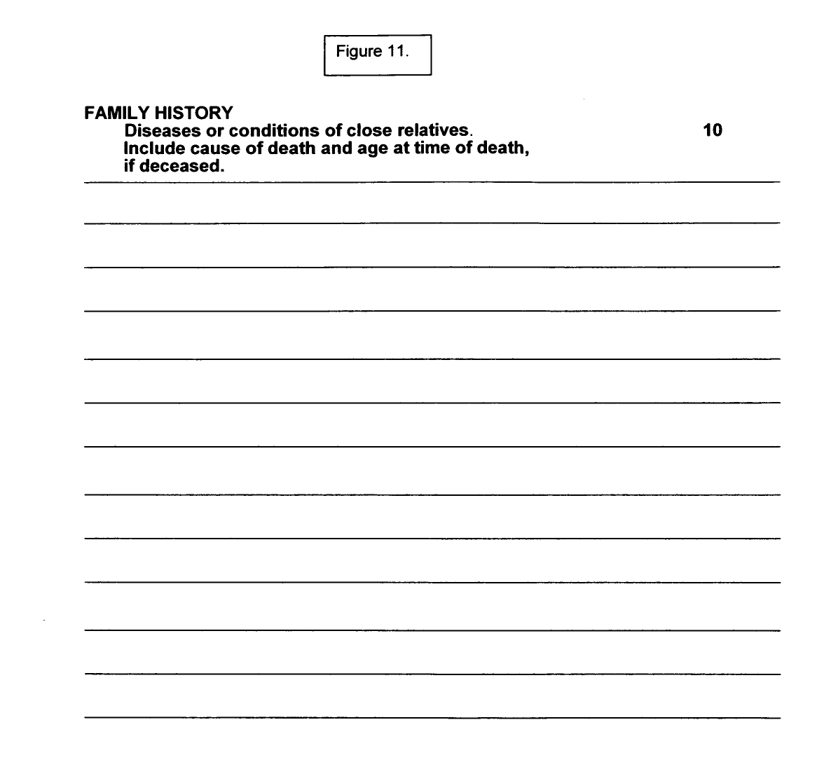

FIG. 11. Page 10 of personal health record.

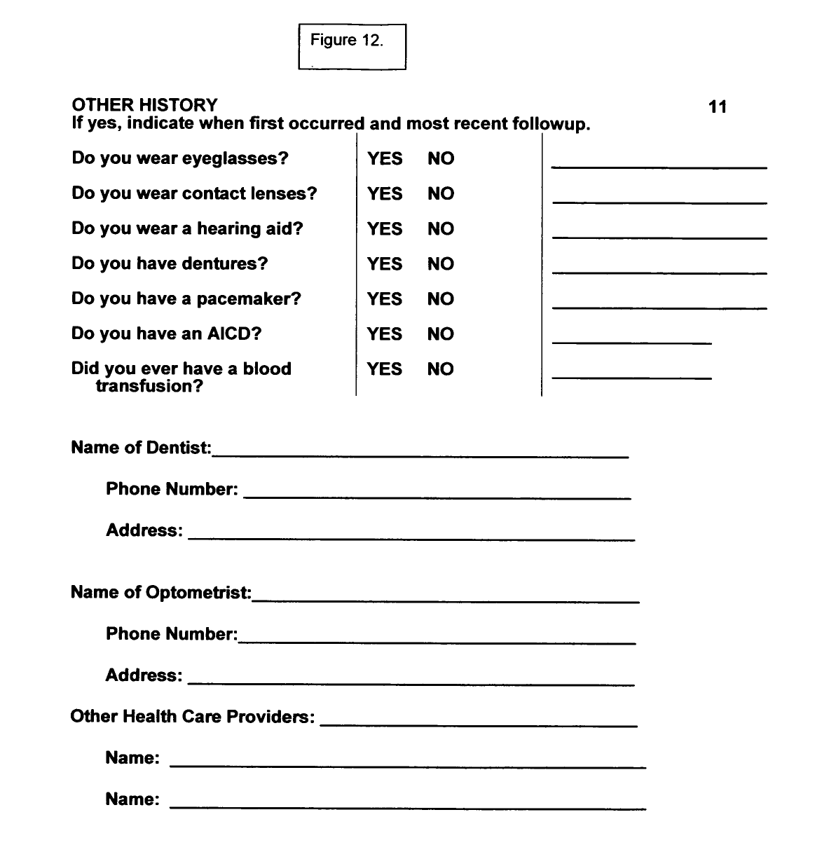

FIG. 12. Page 11 of personal health record.

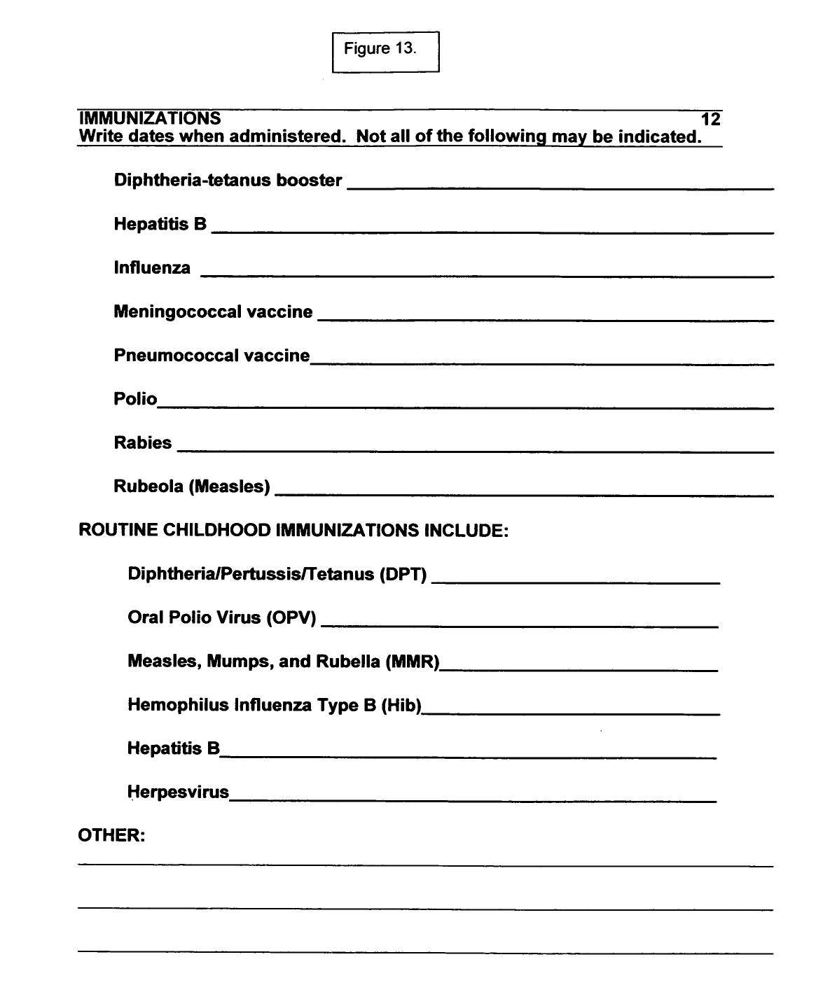

FIG. 13. Page 12 of personal health record.

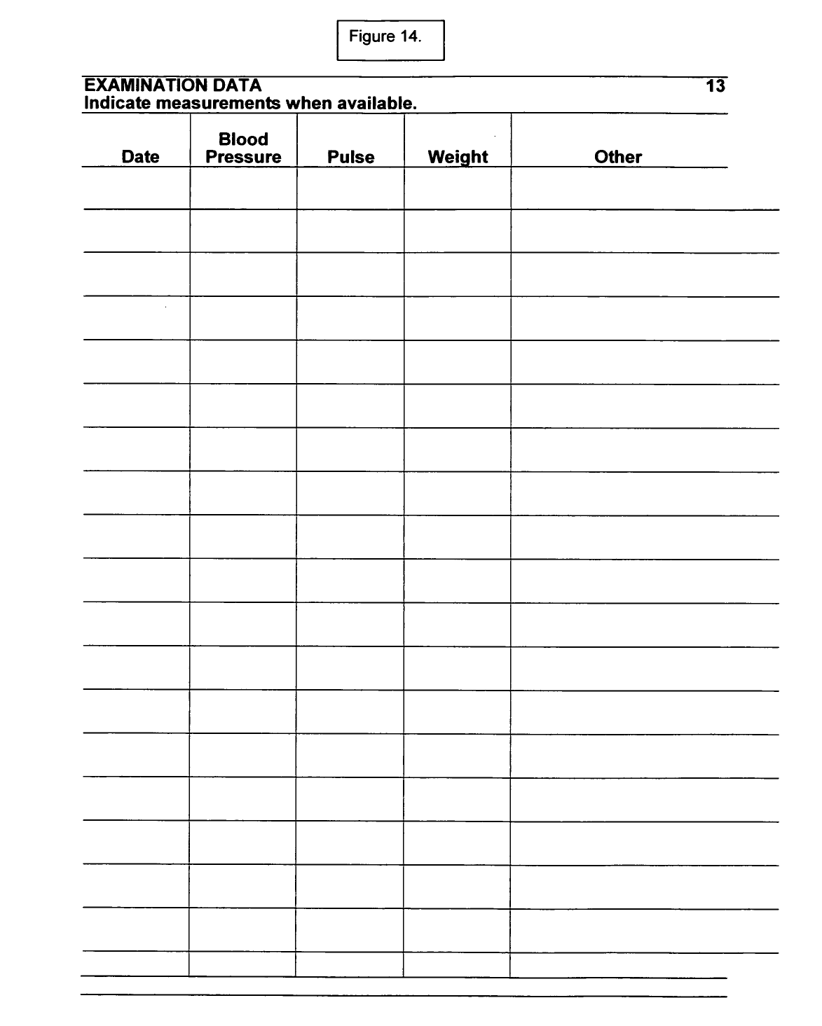

FIG. 14. Page 13 of personal health record.

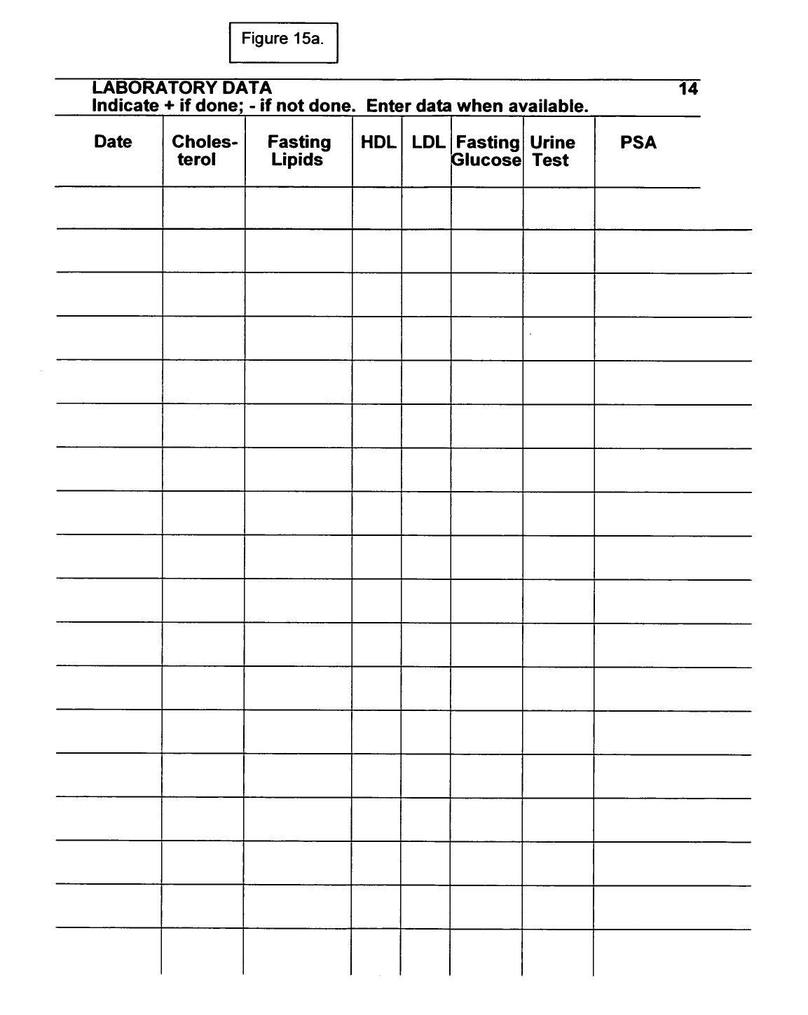

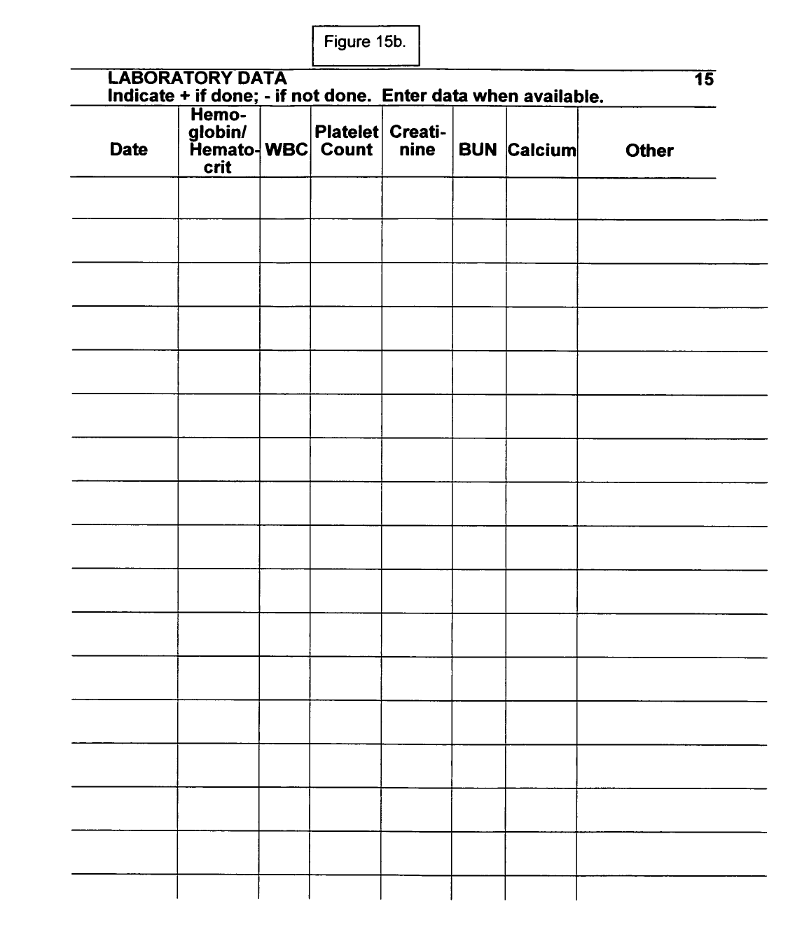

FIG. 15a. Page 14 of personal health record.

FIG. 15b. Page 15 of personal health record

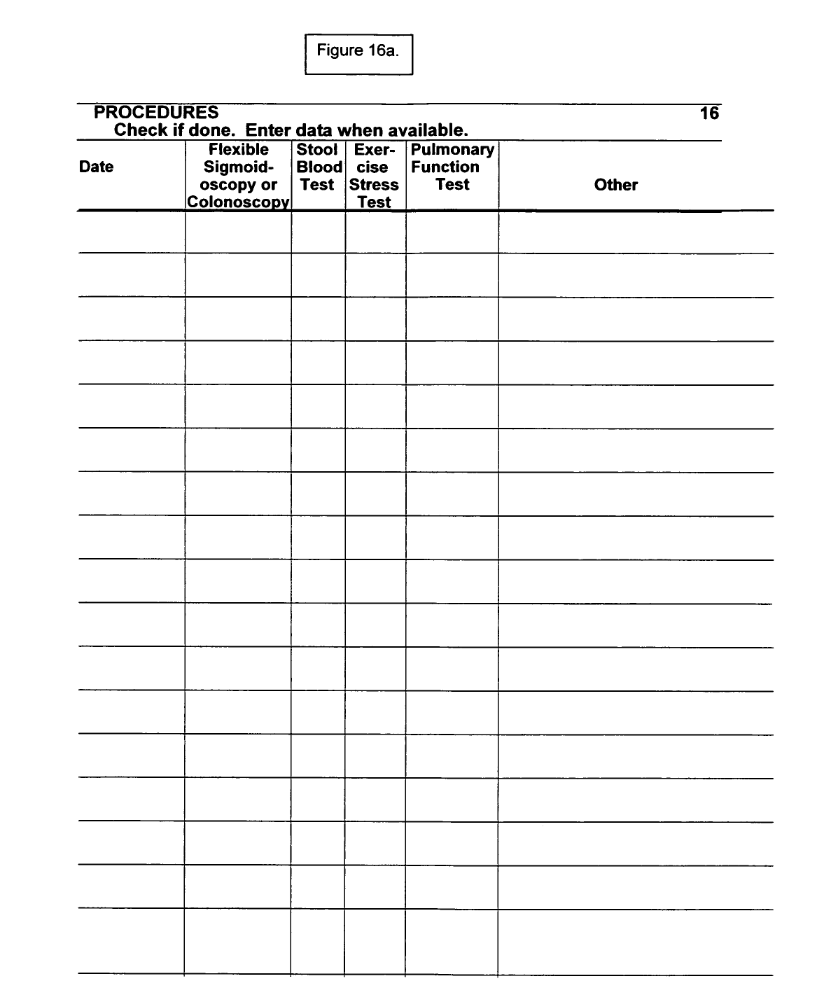

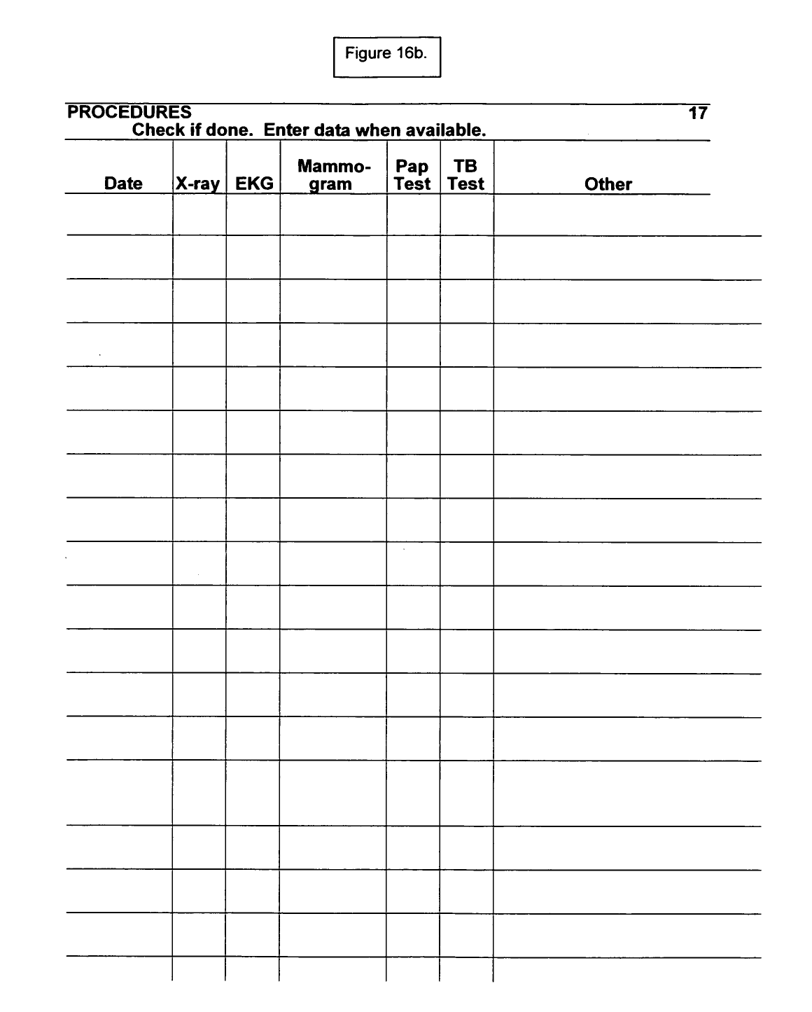

FIG. 16a. Page 16 of personal health record.

FIG. 16b. Page 17 of personal health record.

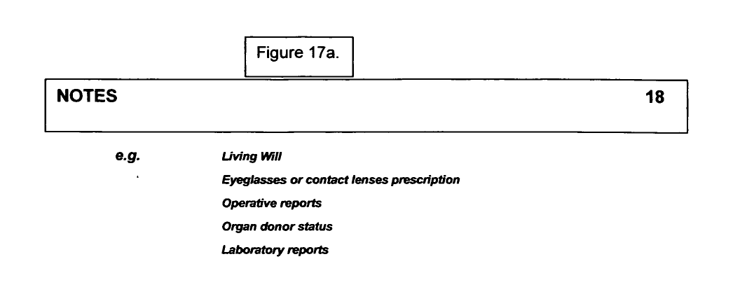

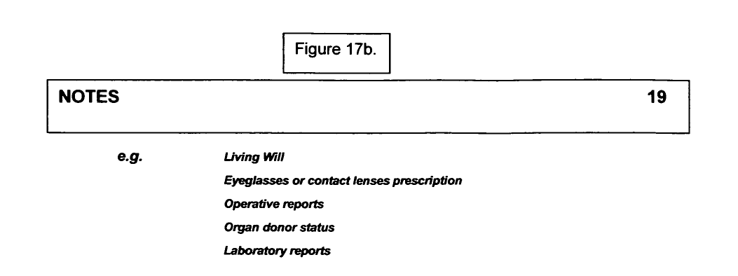

FIG. 17a. Page 18 of personal health record.

FIG. 17b. Page 19 of personal health record.

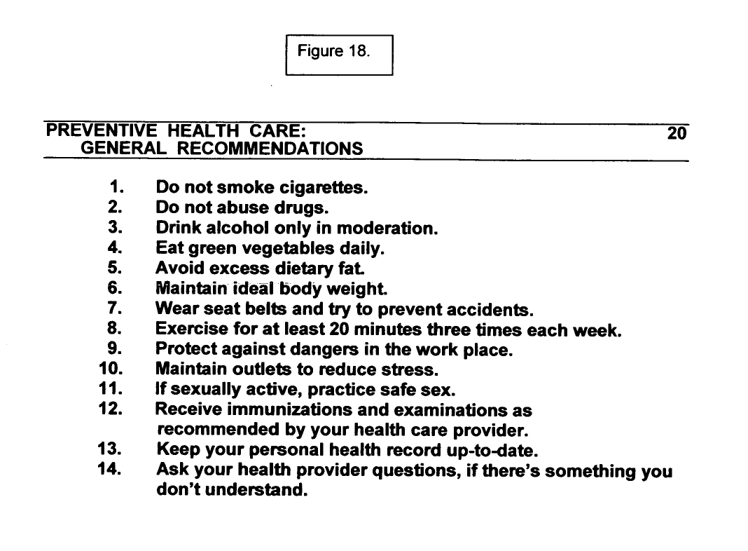

FIG. 18. Page 20 of personal health record.

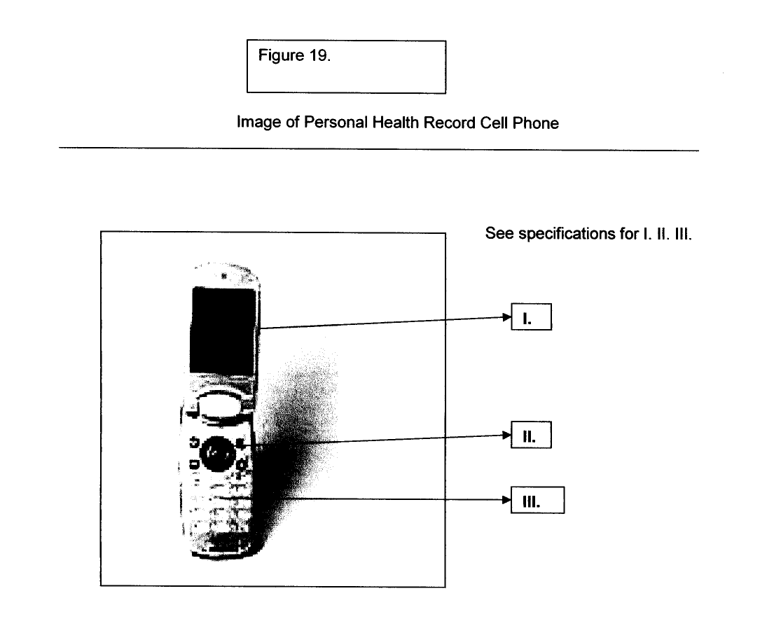

FIG. 19. Prototype image of cell phone.
1. The cell phone will be able to receive electronic source information that will automatically be stored as text files in selected categories, including images, laboratory data, physician notes. The information will be viewed on the screen, designated as I. The PHR database, as identified in Pages 1-20 (FIGS. 2-18) will appear on the screen.
2. Function keys designated as II. will be used to navigate through each page and from one page to another.
3. The keyboard of the cell phone will be similar to commercially available cell phones and will include numeric and alphabetic characters that will be used as they are commonly used in text messaging. The keyboard is designated as III. The keyboard will enable typing vital health information into the personal health record.

### DRAWINGS NECESSARY TO UNDERSTAND THE INVENTION

### Per 35 U.S.C. §113

These follow on Pages 11-32.
A single view is provided since this is what will appear on the screen of the cell phone.
3. The keyboard of the cell phone will be similar to commercially available cell phones and will include numeric and alphabetic characters that will be used as they are commonly used in text messaging.
4. The cell phone will be able to receive electronic source information that will automatically be stored as text files in selected categories, including images, laboratory data, physician notes.

1. The invention will provide a technological innovation to medical record keeping that will enable patients to have access to their medical data, to store it for the long term, and to share it with other health care providers.
The method of claim 1 will be to store health information in a cell phone owned by a patient.
The method of claim 1 will be achieved by a link to the electronic medical record of the health care provider.
The method of claim 1 will be achieved by the addition of information to the personal health record screens placed on the cell phone by the patient or the patient's designee.
